(19) United States
(12) Patent Application Publication
(10) Pub. No.: US 2025/0335043 A1
(43) Pub. Date: Oct. 30, 2025

(54) TOUCHPAD AND KEYBOARD INTEGRATED DEVICE

(71) Applicant: Silicon Integrated Systems Corp., Hsinchu (TW)

(72) Inventors: Wei-en SHIH, Hsinchu (TW); Yung Jui LIN, Hsinchu (TW); Keng-nan CHEN, Hsinchu (TW)

(73) Assignee: Silicon Integrated Systems Corp., Hsinchu (TW)

(21) Appl. No.: 19/190,859

(22) Filed: Apr. 28, 2025

(30) Foreign Application Priority Data
Apr. 29, 2024 (TW) 113115984

(51) Int. Cl. G06F 3/0354; G06F 3/02

(52) U.S. Cl. CPC G06F 3/03547; G06F 3/021

(57) ABSTRACT

A touchpad and keyboard integrated device is provided and includes: a carrier board; a keyboard circuit disposed above the carrier board and including a plurality of button areas; a plurality of buttons, one of the buttons being correspondingly disposed in one of the button areas; and a flexible film touch panel covering the plurality of buttons and including a touch area. When a touch position occurs in the touch area, the flexible film touch panel generates a touch signal, and when the flexible film touch panel is pressed, one of the buttons below a pressed position causes an output signal to be generated in a corresponding button area.

### CROSS REFERENCE TO RELATED APPLICATIONS

The application claims the benefit of priority, under the Paris Convention, of Taiwan Application No. 113115984 filed on Apr. 29, 2024. The disclosures of the abovementioned application are all incorporated by reference as if fully set forth herein in their entirety.

### TECHNICAL FIELD

The present application relates to a touchpad and keyboard integrated device, and more particularly to a touchpad and keyboard integrated device having both touchpad and multi-point keyboard button input functions.

### BACKGROUND TECHNOLOGY

General electronic products, such as liquid crystal displays, notebook computers, smart washing machines, and car navigation systems, not only use LCD panels to display images, but also have buttons for users to operate. However, areas where physical buttons are provided are separated from each other. Moreover, due to limitations of the switch mechanism and circuit layout of the buttons, in order to add button areas, valuable panel space of electronic products is often wasted. Furthermore, if an input space of an electronic product is too small, a user experience of the device will be poor, and a diversity of input methods will also be limited. For users, a time required to input complex commands will also increase due to the limitations on input methods.

In addition, in the prior art, keyboards, mice, touchpads, and other devices are all independent input devices, and it is difficult to combine them into one device without interfering with each other's functions. Furthermore, it is difficult to share the wiring of various types of devices, thus limiting a design freedom of electronic products.

Accordingly, it is necessary to provide a touchpad and keyboard integrated device to solve the above technical problems.

### SUMMARY OF INVENTION

To solve the above problems of the prior art, a purpose of the present application is to provide a touchpad and keyboard integrated device, which can enable a single input device to have more types of input methods and a simple circuit design, while reducing signal interference between different types of input methods.

In a first aspect, the present application provides a touchpad and keyboard integrated device, including: a carrier board; a keyboard circuit disposed above the carrier board and including a plurality of button areas; a plurality of buttons, one of the buttons being correspondingly disposed in one of the button areas; and a flexible film touch panel covering the plurality of buttons and including a touch area. When a touch position occurs in the touch area, the flexible film touch panel generates a touch signal, and when the flexible film touch panel is pressed, one of the buttons below a pressed position causes an output signal to be generated in a corresponding button area.

In some embodiments of the present application, the buttons are composed of metal domes.

In some embodiments of the present application, a charge change of the button corresponds to a deformation amount of the button.

In some embodiments of the present application, the touch signal includes position data of the touch position.

In some embodiments of the present application, a surface of the flexible film touch panel is provided with keyboard text.

In a second aspect, the present application also provides a touchpad and keyboard integrated device, including: a carrier board; a keyboard circuit disposed above the carrier board and including a plurality of button areas; a plurality of buttons, one of the buttons being correspondingly disposed in one of the button areas; a flexible film touch panel covering the plurality of buttons; and an active stylus including a signal receiving and outputting portion communicatively connected to the flexible film touch panel. The flexible film touch panel receives an active transmission signal output by the signal receiving and outputting portion to generate a position signal, and when the flexible film touch panel is pressed, one of the buttons below a pressed position causes an output signal to be generated in a corresponding button area.

In some embodiments of the present application, when a touch position occurs in a touch area, the flexible film touch panel generates a touch signal.

In some embodiments of the present application, the buttons are composed of metal domes.

In some embodiments of the present application, the position signal includes tilt angle data and positioning data of the active stylus relative to the flexible film touch panel.

Compared to the prior art, the present application provides the touchpad and keyboard integrated device, which provides an input device that combines a pressing function and a touch screen through the carrier board, the keyboard circuit disposed above the carrier board, the plurality of buttons correspondingly disposed on the button areas, and the flexible film touch panel disposed on the buttons. A film-type touch panel covers an upper surface of an overall keyboard structure of the touchpad and keyboard integrated device. The plurality of buttons are separately and independently arranged between the keyboard circuit and the flexible film touch panel, so that the touchpad and keyboard integrated device has functions of touch control and buttons control at the same time. At the same time, by separately setting the plurality of buttons, even if the buttons in the button areas are pressed, signal outputs between the buttons will not interfere with each other.

The following is a detailed description of the specific embodiments in conjunction with the accompanying drawings, which will make it easier to understand a purpose, technical content, characteristics, and effects achieved by this application.

### BRIEF DESCRIPTION OF THE DRAWINGS

FIG. 1 is a schematic diagram of a touchpad and keyboard integrated device according to an embodiment of the present application.

FIG. 2 is a top view of a touchpad and keyboard integrated device according to an embodiment of the present application.

FIG. 3 is a top view of a touchpad and keyboard integrated device according to another embodiment of the present application.

FIG. 4 is a top view of a touchpad and keyboard integrated device according to another embodiment of the present application.

FIG. 5 is a schematic diagram of a touchpad and keyboard integrated device according to another embodiment of the present application.

### DETAILED DESCRIPTION OF THE EMBODIMENTS

Technical solutions in the embodiments of the present application will be clearly and completely described below in conjunction with the accompanying drawings in the embodiments of the present application. Apparently, the described embodiments are only part of the embodiments of the present application, rather than all the embodiments. In addition, it should be understood that the specific embodiments described herein are only used to illustrate and explain the present application, and are not used to limit the present application. In the drawings, the same or similar reference numerals represent the same or similar element.

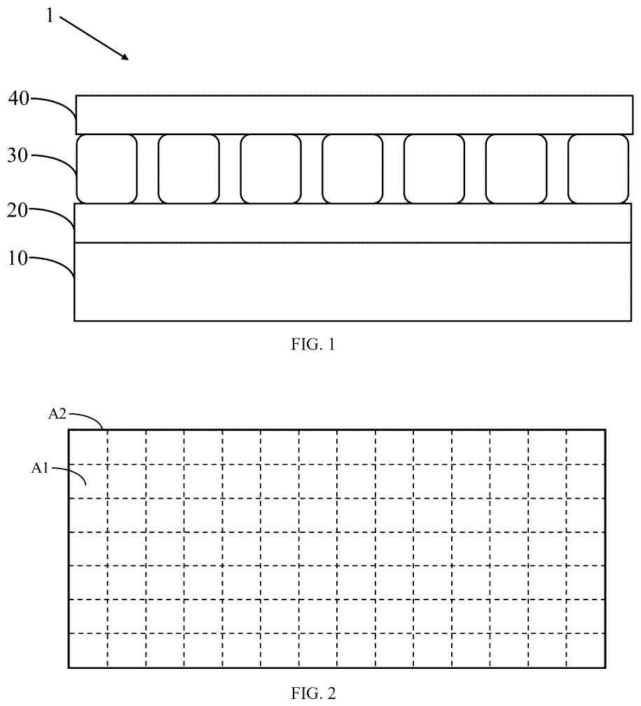

Refer to FIG. 1, which is a schematic diagram of a touchpad and keyboard integrated device according to an embodiment of the present application. A touchpad and keyboard integrated device 1 provided in the present application includes: a carrier board 10; a keyboard circuit 20 disposed above the carrier board 10 and including a plurality of button areas A1; a plurality of buttons 30, one of the buttons 30 being disposed on one of the button areas A1; and a flexible film touch panel 40 covering the plurality of buttons 30 and including a touch area A2. When a touch position occurs in the touch area A2, the flexible film touch panel 40 generates a touch signal in the touch area A2. When the flexible film touch panel 40 is pressed, one of the buttons 30 below a pressed position cause an output signal to be generated in the corresponding button area A1. Therefore, a panel of the touchpad and keyboard integrated device 1 provided by the present application not only senses the touch signal through the touch area A2 but also generates the output signal by pressing the button area A1 in the same area.

In some embodiments of the present application, the buttons 30 are composed of metal domes. Thus, when the flexible film touch panel 40 is pressed, the button 30 can rebound quickly, providing the user with more direct button feedback. Alternatively, in some further embodiments of the present application, the buttons 30 are rubber buttons made of rubber material. Through the deformation and restoring force of the rubber material, it provides users with tactile sensation and feedback when pressing the button.

The buttons 30 are independently arranged on the button areas of the keyboard circuit 20. Thus, when the flexible film touch panel 40 is pressed, only the button area where the corresponding button 30 is arranged will generate the output signal. Therefore, the touchpad and keyboard integrated device 1 provided in the present application is capable of sensing the touch position through the touch signal via the flexible film touch panel 40 at a top of the device. Moreover, when the user presses different positions of the flexible film touch panel 40 at the same time, the keyboard circuit 20 can output output signals at different positions according to the pressed positions at the same time. Thus, through the touchpad and keyboard integrated device 1 provided by the present application, the user can output operation instructions by combining touching the flexible film touch panel 40 and pressing the flexible film touch panel 40 at different positions.

A relationship between the button areas A1 and the touch areas A2 of the present application will be described below through a top view of the touchpad and keyboard integrated device.

In detail, refer to FIG. 2, which is a top view of a touchpad and keyboard integrated device according to an embodiment of the present application. In this embodiment, different button areas A1 correspond to a bottom of the touch area A2 of the touchpad and keyboard integrated device. The button areas A1 are located directly below the touch areas A2 and are indicated by a dotted line in the figure. That is, each area on an upper surface of the touchpad and keyboard integrated device has both the button area A1 and the touch area A2, and the two areas are not separately arranged. Therefore, the user can input a sliding track on the touch area A2 on the touchpad and keyboard integrated device, and can also press any position on the flexible film touch panel 40 to output a signal through the corresponding button area A1.

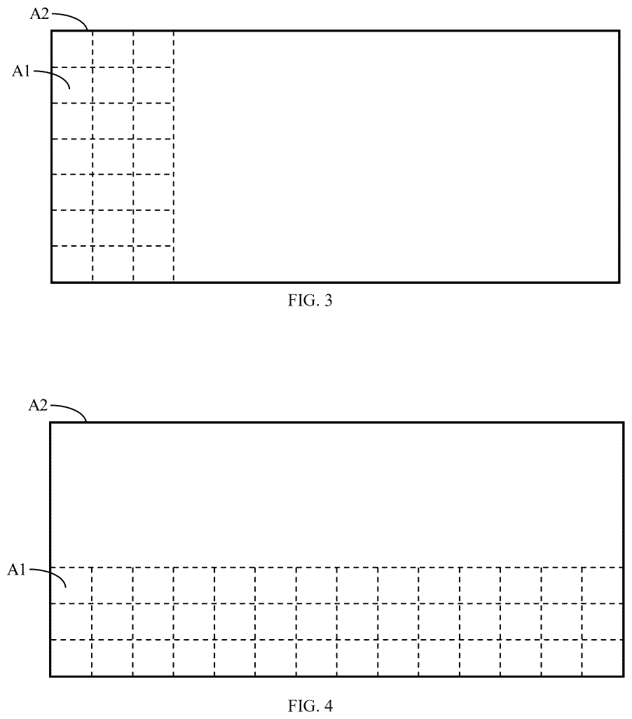

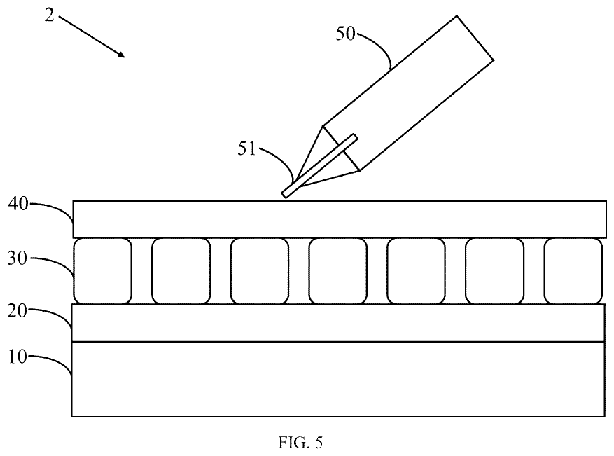

Alternatively, refer to FIG. 3, in this embodiment, different button areas A1 are provided directly below the flexible film touch panel 40 at a left side portion of the touch area A2 of the touchpad and keyboard integrated device. Therefore, on the left side portion of the touchpad and keyboard integrated device, the user can input a sliding track through the touch area A2, and can also press any position of the flexible film touch panel 40 to output a signal. Alternatively, refer to FIG. 4, in this embodiment, different button areas A1 are provided directly below the flexible film touch panel 40 at a bottom portion of the touch area A2 of the touchpad and keyboard integrated device. Therefore, at the bottom portion of the touchpad and keyboard integrated device, the user can input a sliding track through the touch area A2, and can also press any position of the flexible film touch panel 40 to output a signal. That is, in some embodiments of the present application, the button areas A1 can be detachably arranged directly below the touch area A2, so that a partial area of the touchpad and keyboard integrated device has the functions of touch sensing sliding track and press input at the same time.

In some embodiments of the present application, a charge change of the button corresponds to a deformation amount of the button. Thus, the touchpad and keyboard integrated device 1 provided in the present application can also output different pressing instructions according to the different deformation amounts of the buttons 30.

In some embodiments of the present application, the touch signal includes position data of the touch position. Thus, when the user slides a finger on the flexible film touch panel 40 or slides and touches a conductor of the flexible film touch panel 40, the sliding finger or the conductor can play the function of a mouse.

In some embodiments of the present application, a surface of the flexible film touch panel 40 is also provided with keyboard text. Thus, the user can know in advance output effects of pressing different positions of the flexible film touch panel 40 through the keyboard text. The keyboard text may be disposed on the surface of the flexible film touch panel 40 by silk screen printing, thermal transfer printing, laser engraving, water transfer printing, inkjet printing, or other text application methods.

In some embodiments of the present application, the carrier board 10 is a printed circuit board. Thus, the touchpad and keyboard integrated device 1 of the present application can sense the signal changes of different button areas A1 on the keyboard circuit 20 in real time.

A device architecture of a touchpad and keyboard integrated device 2 according to another embodiment of the present application will be described below. The flexible film touch panel 40 of the touchpad and keyboard integrated device 1 is also configured to cooperate with an active stylus 50.

Refer to FIG. 5, a touchpad and keyboard integrated device 2 of another embodiment of the present application includes: a carrier board 10; a keyboard circuit 20 disposed above the carrier board 10 and including a plurality of button areas A1; a plurality of buttons 30, one of the buttons 30 being correspondingly arranged on one of the button areas A1; a flexible film touch panel 40 covering the plurality of buttons 30; and an active stylus 50 including a signal receiving and outputting portion 51 communicatively connected to the flexible film touch panel 40. The flexible film touch panel 40 can receive an active transmission signal output by the signal receiving and outputting portion 51 to generate a position signal. When the flexible film touch panel 40 is pressed, one of the buttons 30 below a pressed position causes an output signal to be generated in the corresponding button area A1.

In some embodiments of the present application, when the touch position occurs in the touch area A2, the flexible film touch panel 40 generates a touch signal. Thus, the user can convert a sliding of a finger or a conductor on the flexible film touch panel 40 into a corresponding movement of a pointer.

In some embodiments of the present application, the buttons 30 are composed of metal domes, and the metal components thereof include at least one of iron (Fc), chromium (Cr), nickel (Ni), cobalt (Co), copper (Cu), aluminum (Al), molybdenum (Mo) or a combination thereof. Alternatively, the buttons 30 are rubber buttons including rubber material. The rubber material includes ethylene propylene diene monomer (EPDM), ethylene/acrylic elastomer (AEM), styrene-butadiene rubber (SBR), isobutylene isoprene rubber (IIR), nitrile butadiene rubber (NBR), natural rubber (NR), silicone, fluororubber (FKM, FPM, VITON), hydrogenated nitrile rubber (HNBR), chloroprene rubber (CR), carboxylated nitrile rubber (XNBR), polyacrylate rubber (ACM), polyester polyurethane (AU), polyether polyurethane (EU), epichlorohydrin rubber (ECO).

In some embodiments of the present application, the position signal includes tilt angle data and positioning data of the active stylus 50 relative to the flexible film touch panel 40. Thus, the touchpad and keyboard integrated device 2 provided by the present application can sense the track change caused by shaking the active stylus 50 to form corresponding operation instructions.

The present application has at least the following beneficial effects. The present application provides the touchpad and keyboard integrated device, which provides an input device that combines a pressing function and a touch screen function through the carrier board 10, the keyboard circuit 20 disposed above the carrier board 10, the plurality of buttons 30 correspondingly disposed on the keyboard areas, and the flexible film touch panel 40 disposed on the buttons 30. The flexible film touch panel 40 covers an upper surface of an overall structure of the touchpad and keyboard integrated device of the present application. The buttons 30 are separately disposed between the keyboard circuit 20 and the flexible film touch panel 40 to achieve the functions of touch control and buttons control at the same time. At the same time, through the separate arrangement of the plurality of buttons 30, even if the buttons in the button areas A1 are pressed, other button areas A1 of the keyboard circuit 20 will not be interfered to generate output signals.

It should be noted that the combination of various elements in the present application preferably forms the above-mentioned multiple embodiments, but this should not be interpreted as a limitation on the present application, that is, the various elements in the present application can also have more combinations and are not limited to the above-mentioned multiple embodiments.

The present description uses specific examples to illustrate principles and implementation methods of the present application. The description of the above embodiments is only used to help understand the technical solutions and core ideas of the present application. Those skilled in the art should understand that they can still modify the technical solutions described in the aforementioned embodiments, or make equivalent substitutions for some of the technical features therein, and these modifications or substitutions do not cause the essence of the corresponding technical solutions to deviate from the scope of the technical solutions of the embodiments of this application.

What is claimed is:

1. A touchpad and keyboard integrated device, comprising:
a carrier board;
a keyboard circuit disposed above the carrier board and comprising a plurality of button areas;
a plurality of buttons, wherein one of the buttons is correspondingly disposed in one of the button areas; and
a flexible film touch panel covering the plurality of buttons and comprising a touch area;
wherein when a touch position occurs in the touch area, the flexible film touch panel generates a touch signal, and when the flexible film touch panel is pressed, one of the buttons below a pressed position causes an output signal to be generated in a corresponding button area.

2. The touchpad and keyboard integrated device according to claim 1, wherein the buttons are composed of metal domes.

3. The touchpad and keyboard integrated device according to claim 1, wherein a charge change of the button corresponds to a deformation amount of the button.

4. The touchpad and keyboard integrated device according to claim 1, wherein the touch signal comprises position data of the touch position.

5. The touchpad and keyboard integrated device according to claim 1, wherein a surface of the flexible film touch panel is provided with keyboard text.

6. The touchpad and keyboard integrated device according to claim 1, wherein the carrier board comprises a printed circuit board.

7. A touchpad and keyboard integrated device, comprising:
a carrier board;
a keyboard circuit disposed above the carrier board and comprising a plurality of button areas;
a plurality of buttons, wherein one of the buttons is correspondingly disposed in one of the button areas;
a flexible film touch panel covering the plurality of buttons; and
an active stylus comprising a signal receiving and outputting portion communicatively connected to the flexible film touch panel;
wherein the flexible film touch panel receives an active transmission signal output by the signal receiving and outputting portion to generate a position signal, and when the flexible film touch panel is pressed, one of the buttons below a pressed position causes an output signal to be generated in a corresponding button area.

8. The touchpad and keyboard integrated device according to claim 7, wherein when a touch position occurs in a touch area, the flexible film touch panel generates a touch signal.

9. The touchpad and keyboard integrated device according to claim 7, wherein the buttons are composed of metal domes.

10. The touchpad and keyboard integrated device according to claim 7, wherein the position signal comprises tilt angle data and positioning data of the active stylus relative to the flexible film touch panel.
